(19) United States
(12) Patent Application Publication
(10) Pub. No.: US 2008/0130531 A1
(43) Pub. Date: Jun. 5, 2008

(54) Transporting packetized voice over WIMAX networks

(76) Inventor: Joey Chou, Scottsdale, AZ (US)

Correspondence Address: TROP PRUNER & HU, PC, 1616 S. VOSS ROAD, SUITE 750, HOUSTON, TX, 77057-2631, US

(21) Appl. No.: 11/633,705

(22) Filed: Dec. 5, 2006

(51) Int. Cl. H04B 1/10; H04B 1/06

(52) U.S. Cl. 370/310; 370/352

(57) ABSTRACT

A two-phase method may be used to transport packetized voice over WiMAX networks. In the first phase, the resources are reserved and in the second phase, when both ends of the call are active, the resources may be activated. In some embodiments, a non-real time polling service service flow is established that may be used both for subscriber station access to the Internet and communications between an SIP client and SIP server, for example, to establish voice-over-Internet Protocol telephone communications.

### BACKGROUND

This relates to the wireless broadband technology known as Worldwide Interoperability for Microwave Accessor (WiMAX) that supports point to multipoint broadband wireless access over a range of up to 30 miles.

WiMAX is intended to compete with Digital Subscriber Line (DSL) and cable modem technologies to provide triple play (data, voice, and video) services. WIMAX is described in the Institute of Electronics and Electrical Engineers (IEEE) Standard 802.16 (2004) (IEEE, Piscataway, N.J. 08855-1331) (LAN/MAN Broadband Wireless LANS).

WiMAX includes a defined set of quality of service mechanisms or hooks in the medium access control and physical sublayers to support data, voice, and video services.

Voice over Internet Protocol or VOIP is becoming increasingly important as a competitor for conventional telephone technologies. It allows telephone calls to be made over the Internet. Currently, the existing standard for WiMAX does not account for voice over Internet Protocol telephony.

### BRIEF DESCRIPTION OF THE DRAWINGS

FIG. 1 is a schematic depiction of one embodiment of the present invention;

FIG. 2 is a schematic depiction of the WiMAX client shown in FIG. 1 in accordance with one embodiment of the present invention;

FIG. 3 is a control flow sequence for one illustrative embodiment of the present invention;

FIG. 4 is a flow chart for base station call activation sequence in accordance with one embodiment of the present invention;

FIG. 5 is a SIP server call control client sequence in accordance with one embodiment of the present invention;

FIG. 6 is a sequence for a subscriber station medium access control in accordance with one embodiment of the present invention; and

FIG. 7 is a control sequence for another embodiment.

### DETAILED DESCRIPTION

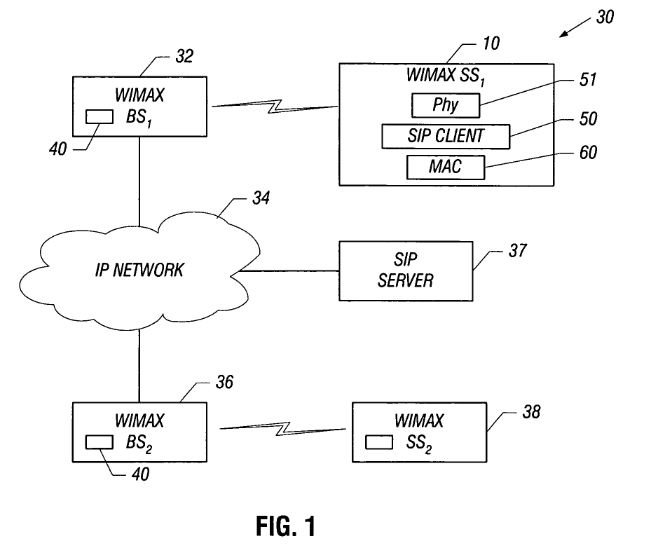

Referring to FIG. 1, a system protocol for providing voice over Internet Protocol telephone calls over a WiMAX network is illustrated at 30. WiMAX is a technology for providing wireless Internet services from a fixed antenna known as a base station. As used herein, a base station is a generalized equipment set providing connectivity management and control of the subscriber station. The subscriber station is a generalized equipment set providing connectivity between subscriber equipment and a base station.

The WiMAX client 10 communicates with the WiMAX base station 32 over a suitable wireless protocol. The base station, in turn, communicates with an Internet Protocol network 34, presumably over wireless or fixed connections.

The Internet Protocol network 34, in turn, communicates with a Session Initiation Protocol (SIP) server 37. SIP is a signaling protocol that establishes sessions in an Internet Protocol network. One such session is a two way telephone call. SIP is a protocol of choice for voice over Internet Protocol technology.

The SIP server 37 operates with an SIP client 50 onboard the WiMAX client 10. Also onboard the WiMAX client 10 is a physical layer 51 and a medium access control (MAC) layer 60. The physical layer 51 provides the air interface to the base station 32.

Also connected to the Internet Protocol network 34 are a large number of base stations and subscriber stations. For example, a base station 36 may be coupled to a subscriber station 38 through a suitable WiMAX communication network. The WiMAX base station may include a process sequence 40 which, in some embodiments of the present invention, may be software to implement control of the base station. In many embodiments, the base station may constitute a processor-based system including a storage medium that stores software to implement the sequence 40.

A connection is a unidirectional mapping between a base station peer and a subscriber station medium access control peer for the purpose of transmitting a service flow's traffic. Connections are identified by a connection identifier (CID). A connection identifier may be a 16-bit value that identifies a connection to equivalent peers in a medium access control of a base station and a subscriber station. It maps to a service flow identifier (SFID) that defines the quality of service parameters of the service flow associated with that connection.

A service flow is a unidirectional flow of medium access control data units on a connection that is provided a particular quality of service. A service flow identifier may be a 32-bit quantity that uniquely identifies the service flow to both a subscriber station and a base station. As used herein, uplink refers to communications from the subscriber station to the base station and down-link covers reverse flows.

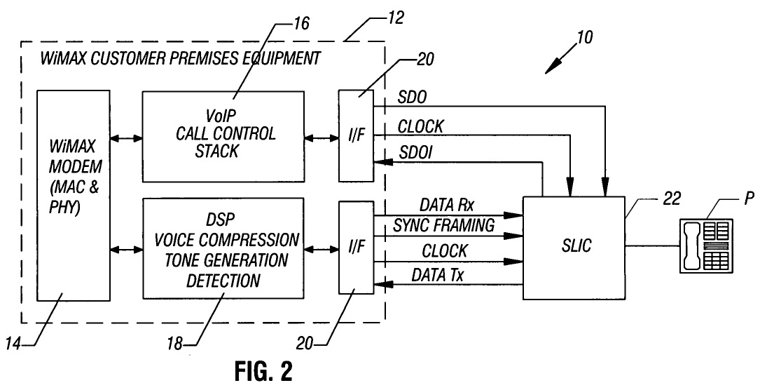

Referring to FIG. 2, one exemplary architecture for the WiMAX client 10 is illustrated. It may include customer premises equipment (CPE) 12 coupled to a subscriber line interface circuit (SLIC) 22. The subscriber line interface circuit 22 adapts the customer premises equipment 12 to a particular legacy phone P.

The customer premises equipment 12 may include a WiMAX modem including both the medium access control and physical layers as indicated at 14. The modem communicates with a voice over Internet Protocol call control stack 16. Also, a digital signal processor 18 provides voice compression, tone generation, and detection. Interface 20 interfaces the control stack and digital signal processor 18 to the subscriber line interface connection 22. Connections include SDO, clock, SDO1, data received, sync framing, clock, and data transmission, as are conventional.

The WiMAX network topology is based on a point to multipoint architecture. It utilizes a centralized control architecture in which the base station controls the uplink and downlink traffic transmission between base station and subscriber station through the wireless media. In the downlink direction, the base station broadcasts data packets to all subscriber stations. The uplink bandwidth is shared between subscriber stations based on time division multiple access (TDMA) architecture. Uplink scheduling services are designed to improve efficiency of bandwidth request/grant processes, while meeting quality of service (QoS) requirements.

Unsolicited grant services (UGS) support constant bit rate or constant bit rate like service flows such as United States T1 or European E1 emulation and voice over Internet Protocol without silence suppression. After a UGS connection is created, bandwidth grants are sent to the subscriber station periodically. As a result, no bandwidth request is needed from the subscriber station for unsolicited grant services.

Real time polling services (rtPS) supports real time service flows that generate variable size data packets on a periodic basis such as Moving Pictures Expert's Group (MPEG) video. Subscriber stations are polled frequently enough to meet the real time requirement of service flows.

Non-real time polling services (nrtPS) support non-real time service flows that require variable size data grant burst types on a regular basis, such as File Transfer Protocol (FTP) and Hyper Text Transfer Protocol (HTTP). Non-real time polling services work like real time polling services except that the polls are issued less frequently.

Best effort services are typically provided by the Internet for web services.

Dynamic service addition or DSA messages create unsolicited grant services or real time polling services service flows when a voice-over-Internet protocol call is initiated. Dynamic service deletion or DSD messages delete service flows when the call is torn down. The DSA messages carry a huge set of quality of service parameters, including traffic priority, maximum sustained traffic rate, maximum traffic burst, and minimum reserve traffic rate, as well as minimum tolerable traffic rate, service flow scheduling type, tolerated jitter, and maximum latency that are processed by the base station scheduler. Therefore, there is a huge overhead to base station or subscriber station when a service flow is created and torn down on a protocol basis.

Thus, a two-phase method may be utilized to transport packetized voice over WiMAX networks. A quality of service parameter set type (QoS_parameter_set_Type) defined in the IEEE 802.16 standard is used to support this two-phase method. The quality of service parameter set type defines the service flow to be in one of the following states. In a provisioned state (provisionedQoSParamSet), a quality of service parameter set is pre-provisioned by the network management system prior to the time that a subscriber station enters the WiMAX network. No service flow has yet been created.

In the admitted state (admittedQoSParamSet), a base station sends a dynamic service addition (DSA) message with the quality of service parameter set type equal to admitted to create the service flow when a subscriber station enters the network. In this state, the base station reserves the resources, but no bandwidth has yet been allocated to such a service flow.

In the active state (activeQoSParamSet), the service flow is active and the bandwidth is allocated to transmit data packets over the interface.

In a first phase, the resources are reserved. This may be done by the base station sending a dynamic service addition message with the quality of service parameter set type equal to the admitted state to reserve bandwidth for packetized voice traffic. In a second phase, call activation or deactivation may be accomplished. This may be done when both ends of a voice call are active. The subscriber station sends a dynamic service change (DSC) message to change the quality of service parameter set type to active. The base station scheduler then allocates the bandwidth for sending the voice packets. When the call ends, the subscriber station sends a dynamic service change message to change the quality of service parameter set type to admitted.

The two-phase method may also use a maximum sustained traffic rate parameter. In the reservation phase, the base station may send a dynamic service addition message with a maximum sustained traffic rate of zero to create a connection. When a call is active, the subscriber station sends a dynamic service change message with a dynamic service addition message with the maximum sustained traffic rate equal to the bandwidth required by the voice over Internet Protocol to allocate the bandwidth for a voice call.

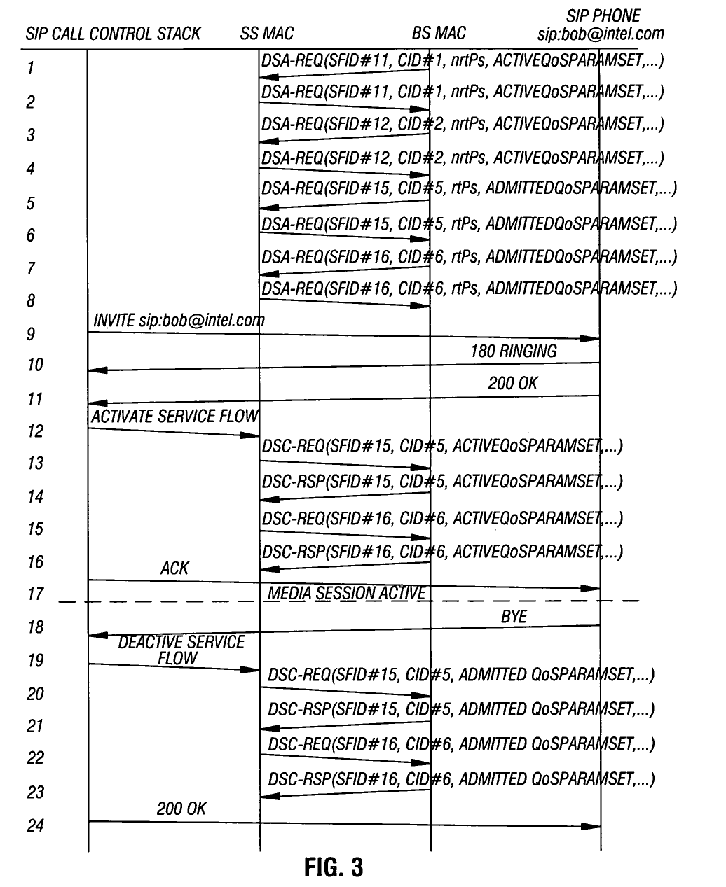

Referring next to FIG. 3, an example of a voice-over-WiMAX control sequence is described which illustrates the integration of the SIP protocol with the WiMAX network. Referring to the numbers on the left hand column, at 1, the base station sends a dynamic service addition request with a quality of service parameter set type equal to the active state to create a non-real time polling services downlink service flow, SFID#11 and CID#1.

Then, at 2, the subscriber station returns a dynamic service addition response message to confirm that the non-real time polling services downlink service flow, SFID#11, CID#1, is created.

At 3, the base station sends a dynamic service addition request with a quality of service parameter set type equal to the active state to create a non-real time polling services uplink service flow, SFID#12 and CID#2.

At 4, the subscriber station returns a dynamic service addition response message to confirm that the non-real time polling services uplink service flow, SFID#12, CID#2, has been created.

SFID#11 and #12 may be used to provide a bidirectional connection for the subscriber station to access the Internet. This bidirectional connection may also be used by the SIP client 50 to communicate with the SIP server 37 in the network.

At 5, the base station sends a dynamic service addition request with a quality of service parameter set type equal to the admitted state to create a real time polling service downlink service flow, SFID#15 and CID#5. This real time polling service flow is intended for voice traffic and is not active. Therefore, the bandwidth is reserved, but not yet allocated.

At 6, the subscriber station returns a dynamic service addition response message to confirm that the real time polling service down link service flow, SFID#15, CID#5, has been created.

At 7, the base station sends a dynamic service addition request with quality of service parameter set type in the admitted state to create a real time polling service uplink service flow, SFID#16 and CID#6. This real time polling service flow is intended for voice traffic and is not active. Therefore, the bandwidth is reserved but not yet allocated.

At 8, the subscriber station returns a dynamic service addition response message to confirm the real time polling service uplink service flow, SFID#16, CID#6, has been created. SFID#15 and #16 may be used to provide bidirectional connections for voice traffic.

At 9, the SIP call control client 16 sends an SIP invite message via CID#2 to initiate a voice over Internet Protocol call to Bob at Intel.com.

At 10, Bob at Intel.com returns message 180, via CID#1, when the Internet Protocol phone is ringing.

At 11, when the called party picks of the phone, Bob at Intel.com returns message 200.

Then, at 12, the call control stack 16 calls an application programming interface (API) to activate the service flow.

At 13, the subscriber station medium access control 60 sends a dynamic service change request message with SFID#15 and a quality of service parameter set type in the active state to activate CID#5 for downlink service flow.

At 14, the subscriber station medium access control returns a dynamic service change response message to signal that the CID#5 has been activated and, therefore, the bandwidth for CID#5 has been allocated.

At 15, the subscriber station medium access control sends a dynamic service change request message with SFID#16 and quality of service parameter set type equal to the active state to activate CID#6 for uplink service flow.

Then, at 16, the subscriber station medium access control returns a dynamic service change response message to signal that CID#6 has been activated and the bandwidth for CID#6 has been allocated.

At 17, the media session is active and the phone conversation is started.

When the call ends at 18, Bob at Intel.com returns a bye message.

At 19, the SIP call control stack 16 calls an application programming interface (API) to deactivate the service flow.

At 20, the subscriber station medium access control sends a dynamic service change request message with SFID#15 and quality of service parameter set type in the admitted state to deactivate CID#5.

At 21, the subscriber station medium access control returns a dynamic service change response message with SFID#15 to signal that CID#5 has been deactivated and so the bandwidth for CID#5 is no longer activated.

At 22, the subscriber station medium access control sends a dynamic service change request message with SFID#16 and quality of service parameter set type in the admitted state to deactivate CID#6.

Then, at 23, the subscriber station medium access control returns a dynamic service change response message with SFID#16 to signal that CID#6 has been deactivated. Therefore, the bandwidth for CID#6 is no longer activated.

Then, at 24, the SIP call control client returns an OK message to indicate that the call ends.

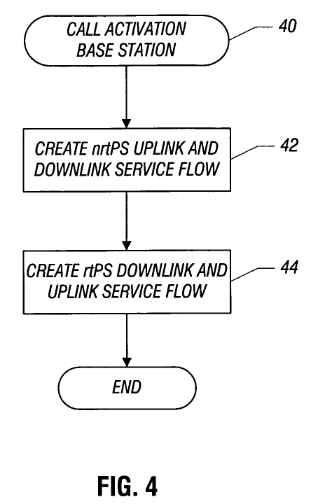

Referring to FIG. 4, the base station call activation sequence 40 is illustrated. This sequence may be implemented in the form of software, in some embodiments of the present invention, stored on a computer readable medium associated with the base station 32. Initially, the base station processor-based system creates a non-real time polling service uplink and downlink service flow as indicated in block 42. Then, it creates a real time polling service downlink and uplink service flow as indicated in block 44.

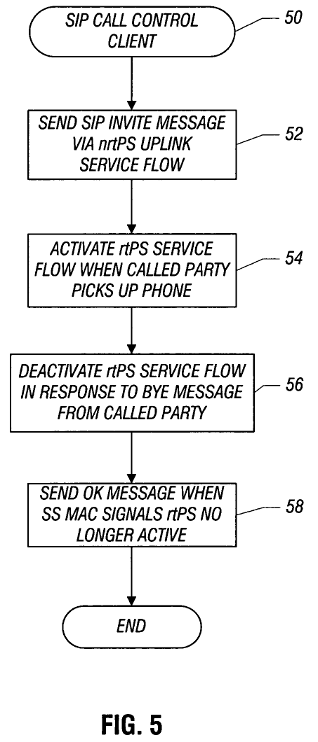

Referring next to FIG. 5, the SIP call control client sequence 50 may be stored as part of the SIP client 50 on the WiMAX client 30 in accordance with one embodiment of the present invention. The SIP call control sequence 50 may be stored on a computer readable medium in the form of software to implement the sequence illustrated. Initially in the sequence, the client sends an SIP invite message via the non-real time polling service uplink service flow as indicated in block 52. Then, a real time polling service service flow is activated when the called party picks up the phone as indicated in block 54. The real time polling service service flow is deactivated in response to the bye message from the called party as indicated in block 56. An OK message is sent when the subscriber station medium access control signals that the real time polling service is no longer active as indicated in block 58.

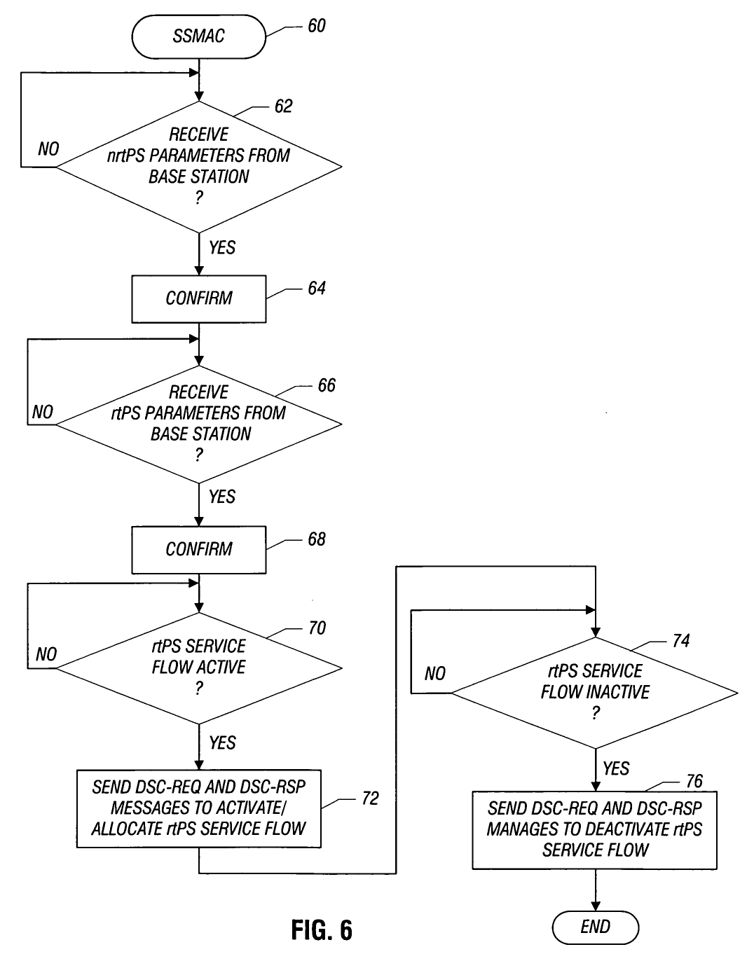

Moving next to the subscriber station medium access control sequence 60, shown in FIG. 6, this too may be implemented in software, in some embodiments, stored on a computer readable medium, which may be part of the WiMAX client 10 of FIG. 1. Initially, the sequence involves receiving non-real time polling sequence parameters from the base station as determined in diamond 62. When these are received, the receipt is confirmed in block 64. Then, the flow waits to receive the real time polling service parameters from the base station, as determined in diamond 66, and, upon receipt, the receipt is confirmed as indicated in block 68.

Next, the sequence determines when the real time polling service service flow is active in diamond 70. When it is active, the sequence sends a dynamic service change request and dynamic service change response message to activate/allocate the real time polling service service flow as indicated in block 72.

The next check, at diamond 74, determines if the real time polling service service flow is now inactive. If so, the sequence sends a dynamic service change request and response message to deactivate the real time polling service service flow as indicated in block 76.

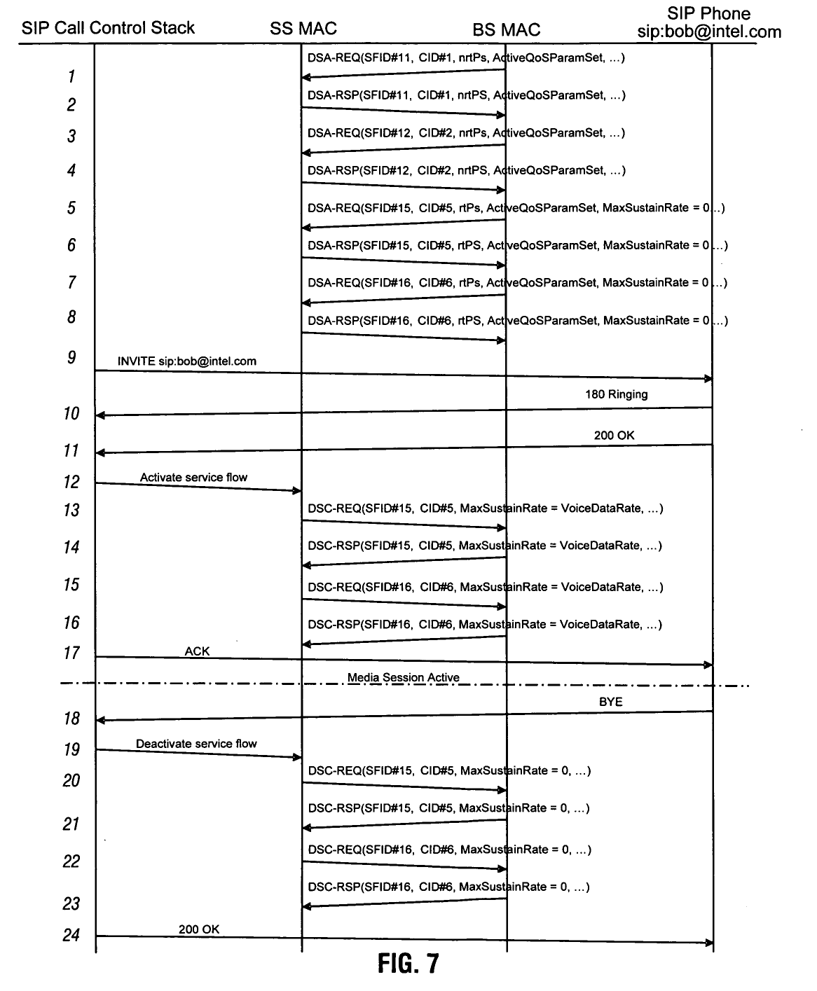

FIG. 7 shows an example of a voice over WiMAX control flow sequence that describes the integration of an SIP protocol with WiMAX networks. It uses a maximum sustain data rate to implement two-phase call control.

At 1, the base station sends a dynamic service addition request with a service parameter set type equal to the active state to create a non-real time polling service and downlink service flow, SFID#11 and CID#1.

Then, at 2, the subscriber station returns a dynamic service addition response message to confirm the non-real time polling services downlink service flow, SFID#11 and CID#1, is created.

At 3, the base station sends a dynamic service addition request with a quality of service parameter set type set equal to the active state to create a non-real time polling services uplink service flow, SFID#12 and CID#2.

At 4, the subscriber station returns a dynamic service addition response message to confirm that the non-real time polling services uplink service flow, SFID#12 and CID#2, has been created. SFID#11 and #12 may be used to provide bidirectional connection for a subscriber station to access the Internet. This bidirectional connection will also be used by the SIP client to communicate with the SIP server in the network.

At 5, the base station sends a dynamic service addition request with a quality of service parameter set type equal to the active state with the maximum sustained rate equal to zero to create a real time polling service downlink service flow, SFID#15 and CID#5. This real time polling service flow is intended for voice traffic and is not active. Therefore, the bandwidth is reserved, but not yet allocated.

At 6, the subscriber station returns a dynamic service addition response message to confirm the real time polling services downlink service flow, SFID#15 and CID#5, is created.

At 7, the base station sends a dynamic service addition request with a quality of service parameter set type equal to the active state and maximum sustained rate equal to zero to create a real time polling service uplink service flow, SFID#16 and CID#6. This real time polling service flow is intended for voice traffic and is not active. Therefore, the bandwidth is reserved, but not yet allocated.

At 8, the subscriber station returns a dynamic service addition response message to confirm the real time polling service uplink service flow, SFID#16 and CID#6, is created. SFID#15 and #16 will be used to provide bidirectional connection for voice traffic.

At 9, the SIP call control client sends an SIP invite message via CID#2 to initiate a voice over Internet protocol call to Bob at Intel.com.

At 10, Bob at Intel.com returns the message 180 via CID#1, when the Internet protocol phone is ringing.

At 11, when the called party picks up the phone, Bob at Intel.com returns message 200.

At 12, the SIP call control stack calls an application programming interface to activate the service flow.

At 13, the subscriber station medium access control 60 sends a dynamic service change request message with SFID#15 and maximum sustained rate equal to the voice data rate to activate CID#5.

At 14, the subscriber station medium access control returns a dynamic service change response message to signal that CID#5 has been activated. Therefore, the bandwidth for CID#5 has been allocated.

At 15, the subscriber station medium access control sends a dynamic service change request message with SFID#16 and the maximum sustained rate equal the voice data rate to activate CID#6.

At 16, the subscriber station medium access control returns a dynamic service change response message to signal that CID#6 has been activated. Therefore, the bandwidth for CID#6 has been allocated.

At 17, the media session is active and the phone conversion is started.

At 18, when the calls ends, Bob at Intel.com returns the BYE message.

At 19, the SIP call control stack calls an application programming interface to deactivate the service flow.

At 20, the subscriber station medium access control sends a dynamic service change request message with SFID#15 and the maximum sustained rate equals zero to deactivate CID#5.

At 21, the subscriber station medium access control returns a dynamic service change response message with SFID#15 to signal that CID#5 has been deactivated. Therefore, the bandwidth for CID#5 is no longer allocated.

At 22, the subscriber station medium access control sends a dynamic service change request message with SFID#16 and the maximum sustained rate equals zero to deactivate CID#6.

At 23, the subscriber station medium access control returns a dynamic service change response message with SFID#16 to signal that CID#6 has been deactivated. Therefore, the bandwidth for CID#6 is no longer allocated.

At 24, the SIP call control client returns an OK message to indicate that the call has ended.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
establishing a non-real time polling service service flow for a subscriber station to access the Internet and to set up a packetized voice communication link.

2. The method of claim 1 wherein establishing a non-real time polling service flow involves establishing a bidirectional connection for said subscriber station.

3. The method of claim 2 including supporting a voice communication link between a session initiation protocol server and client using said non-real time polling service service flow.

4. The method of claim 3 including establishing said Internet connection in a WiMAX network.

5. The method of claim 4 including using a two phase method to transport WiMAX packets.

6. The method of claim 5 including using a quality of service parameter set type.

7. The method of claim 6 including using said quality of service parameter set type to reserve resources before bandwidth is allocated to a service flow.

8. The method of claim 7 including sending a dynamic service addition message with a quality of service parameter set type equal to the admitted state.

9. The method of claim 7 including reserving resources before bandwidth is allocated for a service flow.

10. The method of claim 9 including thereafter activating a real time polling service service flow when a called party picks up a phone.

11. The method of claim 1 including sending a message to change a data rate to support multiple voice streaming.

12. A WiMAX subscriber station comprising:
a physical layer;
a medium access control;
a session initiation protocol client; and
wherein said station to initiate a real time polling service service flow when a called party picks up the phone.

13. The station of claim 12 wherein parameters are provisioned before a real time polling service service flow is activated.

14. The station of claim 13 wherein a non-real time polling service flow is activated before the real time polling service flow is activated.

15. The station of claim 12, said station to communicate with a base station to establish said service flow.

16. The station of claim 15, said station to de-allocate the real time polling service service flow when a WiMAX call is completed.

17. The station of claim 12, said station to send a message to change a data rate to support multiple voice streaming.

18. A WiMAX base station comprising:
a non-real time service flow creator to create a non-real time service flow prior to initiation of a WiMAX telephone call; and
a real time service flow creator to create a real time service flow in response to a called party picking up a phone.

19. The station of claim 18 wherein said non-real time service flow is a non-real time polling service service flow.

20. The station of claim 18 wherein said real time service flow is a real time polling service service flow.

21. The station of claim 18 wherein said non-real time service flow is bidirectional.

22. The station of claim 18, said station to use a session initiation protocol for packetized voice communications.

23. The station of claim 18, said station to receive a message to change a data rate to support multiple voice streaming.

24. A computer readable medium storing instructions that enable a processor-based system to:
establish a non-real time polling service service flow for a subscriber station to access the Internet and to set up a packetized voice communication link.

25. The medium of claim 24, wherein storing instructions further comprises to establish a bidirectional connection for said subscriber station.

26. The medium of claim 24, wherein storing instructions further comprises to support a voice communication link between a session initiation protocol server and client using said non-real time polling service service flow.

27. The medium of claim 24, wherein storing instructions further comprises to establish said Internet connection in a WiMAX network.

28. The medium of claim 24, wherein storing instructions further comprises to use a two phase method to transport WiMAX packets.

29. The medium of claim 24, wherein storing instructions further comprises to use a quality of service parameter set type.

30. The medium of claim 24, wherein storing instructions further comprises to send a message to change a data rate to support multiple voice streaming.
